(19) United States
(12) Patent Application Publication
(10) Pub. No.: US 2010/0177007 A1
(43) Pub. Date: Jul. 15, 2010

(54) ANTENNA MODULE AND METHOD FOR MAKING THE SAME

(75) Inventor: SHANG WU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/509,057

(22) Filed: Jul. 24, 2009

(30) Foreign Application Priority Data
Jan. 15, 2009 (CN) 200910300188.0

(51) Int. Cl. H01Q 1/40; B29C 45/16

(52) U.S. Cl. 343/873; 264/104

(57) ABSTRACT

An antenna module includes a carrier made of non-conductive resin and an antenna layer made of conductive material attached to the carrier. The invention also discloses a method for making the antenna module.

### BACKGROUND

1. Technical Field

The present disclosure relates to antenna modules and methods for making the same, particularly, to an antenna module used in a portable electronic device and a method for making the same.

2. Description of Related Art

With the developments of wireless communication and information processing technologies, portable wireless communication devices such as mobile phones and personal digital assistants (PDAs) are now in widespread use, and consumers may now enjoy the full convenience of high tech products almost anytime and anywhere.

Typical portable electronic devices include an antenna module assembled therein to transmit and receive electromagnetic waves. The antenna module includes a carrier and a radiator element. The radiator element is assembled on the carrier by hot melting or bonding method.

However, the method of hot melting or bonding is complicated. This can greatly reduce production efficiency. Moreover, the radiator element may be secured on the carrier with lower precision of orientation, thereby degrading call performance of the portable electronic devices.

Therefore, there is a room for improvement within the art.

### BRIEF DESCRIPTION OF THE DRAWINGS

Many aspects of an antenna module and method for making the same can be better understood with reference to the following drawings. The components in the drawings are not necessarily to scale, the emphasis instead being placed upon clearly illustrating the principles of the present antenna module and method for making the same. Moreover, in the drawings, like reference numerals designate corresponding parts throughout the several views:

FIG. 1 is a perspective view of a carrier of an antenna module in accordance with an exemplary embodiment.

FIG. 2 is a perspective view of an antenna layer of the antenna module formed on the carrier.

### DETAILED DESCRIPTION OF THE EMBODIMENTS

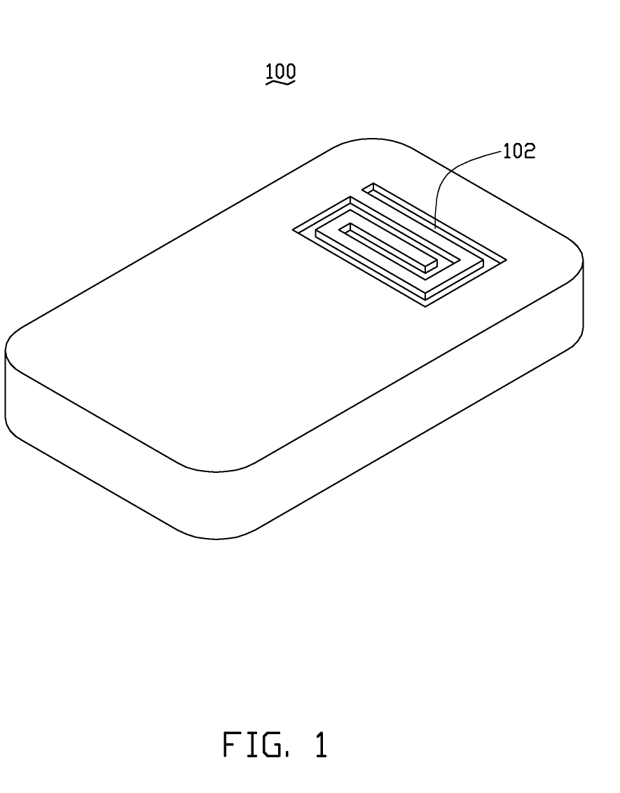

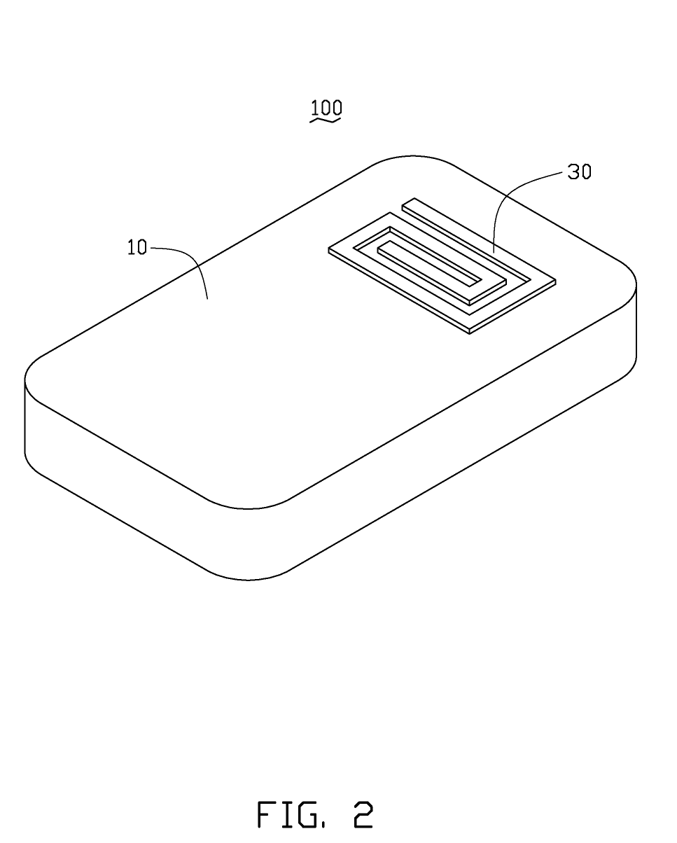

FIGS. 1 and 2 show an antenna module 100 used in portable electronic devices, such as mobile phone terminals, digital cameras, and others. The antenna module 100 includes a carrier 10, which can be the housing of the portable electronic device, and an antenna layer 30 moldingly attached to the carrier 10.

The carrier 10 is made of non-conductive resin selected from a group consisting of polycarbonate (PC) and acrylonitrile-butadiene-styrene (ABS). The carrier 10 includes a patterned groove 102 defined in a desired shape corresponding to that of the antenna layer 30.

The antenna layer 30 is made of conductive material selected from a group consisting of polyphenylene sulfide (PPS), polypyrrole (PPY), polythiophene (PT), and polythiazole. Electric conductivity of the conductive material is similar to that of copper or silver. The antenna layer 30 is moldingly embedded in the patterned groove 102 by injection molding.

An exemplary embodiment of a method for making the antenna module 100 may comprise the following steps:

An injection molding machine is provided. The non-conductive resin is injected into a mold of the injection molding machine to form the carrier 10. The carrier 10 defines the patterned groove 102. Then, the conductive material is injected into the injection molding machine to form the antenna layer 30 attached to the carrier 10.

The antenna layer 30 is directly formed on the carrier 10 by the injection molding molding, thereby improving production efficiency. Furthermore, the antenna layer may be secured on the carrier with higher precision of orientation, thereby improving call performance of the portable electronic devices.

It is to be understood, that the patterned groove 102 can also be a protrusion positioned on the carrier 10.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An antenna module, comprising:
a carrier made of non-conductive resin; and
an antenna layer made of conductive material attached to the carrier.

2. The antenna module as claimed in claim 1, wherein the conductive material is selected from a group consisting of polyphenylene sulfide, polypyrrole, polythiophene, and polythiazole.

3. The antenna module as claimed in claim 1, wherein the non-conductive resin is selected from a group consisting of polycarbonate and acrylonitrile-butadiene-styrene.

4. The antenna module as claimed in claim 1, wherein the carrier includes a patterned groove, the antenna layer embedded in the patterned groove.

5. A method for making an antenna module, comprising steps of:
injecting non-conductive resin into an injection molding machine to form a carrier, and
injecting conductive material into the injection molding machine to form an antenna layer attached to the carrier.

6. The method for making an antenna module as claimed in claim 5, wherein the conductive material is selected from a group consisting of polyphenylene sulfide, polypyrrole, polythiophene, and polythiazole.

7. The method for making an antenna module as claimed in claim 5, wherein the non-conductive resin is selected from a group consisting of polycarbonate and acrylonitrile-butadiene-styrene.

8. The method for making an antenna module as claimed in claim 5, further comprising forming a patterned groove in the carrier, and embedding the antenna layer in the patterned groove.
